(19) United States
(12) Patent Application Publication
(10) Pub. No.: US 2026/0330304 A1
(43) Pub. Date: Oct. 22, 2026

(54) CONTENT GENERATION METHOD AND APPARATUS, AND COMPUTER-READABLE STORAGE MEDIUM

(71) Applicant: Beijing Zitiao Network Technology Co., Ltd., Beijing (CN)

(72) Inventors: Youjia SHEN, Beijing (CN); Ziyang ZHENG, Beijing (CN)

(21) Appl. No.: 19/464,207

(22) Filed: Jan. 29, 2026

(30) Foreign Application Priority Data
Feb. 27, 2025 (CN) 202510229212.5

(51) Int. Cl. G06N 20/00; H04L 51/02

(52) U.S. Cl. CPC G06N 20/00; H04L 51/02

(57) ABSTRACT

The present disclosure relates to a content generation method and apparatus, and a computer-readable storage medium. The content generation method includes: receiving an image and an indication for the image that are input by a user; determining a feature attribute of to-be-generated content based on environment information in the image; and generating content based on the indication, the image, the feature attribute, and auxiliary understanding information of the image.

### CROSS-REFERENCE TO RELATED APPLICATIONS

The present application is based on and claims priority to China Patent Application No. 202510229212.5 filed on Feb. 27, 2025, the disclosure of which is incorporated by reference herein in its entirety.

### TECHNICAL FIELD

The present disclosure relates to a content generation method and apparatus, and a computer-readable storage medium.

### BACKGROUND

With the rapid iteration of digital technologies, a large number of applications with diverse functions have emerged, which are deeply embedded in all aspects of people’s lives, from daily travel, shopping and consumption, to social entertainment, knowledge learning, and have become important tools in modern people’s lives. At the same time, various systems for intelligent interaction have also been continuously upgraded, providing a new mode for communication and interaction between users and electronic devices.

Intelligent interaction assistants can recognize users’ intentions and provide answers, bringing more convenience to people’s daily life and work.

### SUMMARY

According to some embodiments of the present disclosure, a content generation method is provided, including: receiving an image and an indication for the image that are input by a user; determining a feature attribute of to-be-generated content based on environment information in the image; and generating content based on the indication, the image, the feature attribute, and auxiliary understanding information of the image.

According to some other embodiments of the present disclosure, a content generation apparatus is provided, including: a receiving module configured to receive an image and an indication for the image that are input by a user; a determination module configured to determine a feature attribute of to-be-generated content based on environment information in the image; and a generation module configured to generate content based on the indication, the image, the feature attribute, and auxiliary understanding information of the image.

According to some other embodiments of the present disclosure, an electronic device is provided, including: a memory; and a processor coupled to the memory, where the processor is configured to execute, based on instructions stored in the memory, the content generation method according to some embodiments of the present disclosure.

According to some other embodiments of the present disclosure, a non-transitory computer-readable storage medium is provided, having computer program instructions stored thereon, where when the instructions are executed by a processor, the content generation method according to some embodiments of the present disclosure is implemented.

According to some other embodiments of the present disclosure, a computer program product is provided, including computer program instructions, where when the computer program instructions are executed by a processor, the content generation method according to some embodiments of the present disclosure is implemented.

Other features, aspects, and advantages of the present disclosure become apparent from the following detailed description of the embodiments of the present disclosure with reference to the accompanying drawings.

### BRIEF DESCRIPTION OF THE DRAWINGS

Embodiments of the present disclosure are described hereinafter with reference to the drawings. It is to be understood that the drawings in the following description relate to some embodiments of the present disclosure, but are not to be construed as limiting the present disclosure. In the drawings:

FIG. 1 is a flowchart of a content generation method according to some embodiments of the present disclosure;

FIG. 2 is a schematic diagram of receiving a user input according to some embodiments of the present disclosure;

FIG. 3A is a schematic diagram of receiving auxiliary understanding information according to some embodiments of the present disclosure;

FIG. 3B is a schematic diagram of receiving auxiliary understanding information according to some other embodiments of the present disclosure;

FIG. 4 is a schematic diagram of displaying a reply according to some embodiments of the present disclosure;

FIG. 5 is a block diagram of a content generation apparatus according to some embodiments of the present disclosure;

FIG. 6 is a block diagram of an electronic device according to some embodiments of the present disclosure;

FIG. 7 is a block diagram of an electronic device according to some other embodiments of the present disclosure.

It is to be understood that, for ease of description, the sizes of the components shown in the drawings are not necessarily drawn to scale. Throughout the drawings, identical or similar reference numerals refer to identical or similar components. Therefore, once an item is defined in one drawing, it may not be further discussed in subsequent drawings.

### DETAILED DESCRIPTION

The technical solutions in the embodiments of the present disclosure are clearly and completely described in the following with reference to the drawings in the embodiments of the present disclosure. It is to be understood that the present disclosure may be implemented in various forms and should not be construed as limited to the embodiments set forth herein.

It is to be understood that the steps described in the method implementations of the present disclosure may be performed in different orders and/or in parallel. Furthermore, the method implementations may include additional steps and/or omit the steps shown. The scope of the present disclosure is not limited in this respect. Unless otherwise specified, the relative arrangements of the components and steps set forth in these embodiments are to be construed as merely exemplary and do not limit the scope of the present disclosure.

The term "include/comprise" and the variants thereof used in the present disclosure mean open terms that at least include the elements/features following the term, but do not exclude other elements/features, that is, "include/comprise but not limited to". The term "based on" means "at least partially based on".

It is to be noted that the modifiers "one" and "a plurality of" mentioned in the present disclosure are illustrative and not restrictive, and those skilled in the art should understand that the modifiers should be understood as "one or more" unless otherwise clearly indicated in the context.

The names of messages or information exchanged between a plurality of apparatuses in the implementations of the present disclosure are used for illustrative purposes only, and are not used to limit the scope of the messages or information.

User information (including, but not limited to, user device information, user personal information, and the like) and data (including, but not limited to, data for analysis, stored data, displayed data, and the like) involved in the present disclosure are information and data authorized by the user or fully authorized by all parties, and the collection, use, and processing of the related data need to comply with the related laws, regulations, and standards of the related countries and regions, and corresponding operation entry is provided for the user to choose authorization or rejection.

Embodiments of the present disclosure are described in detail hereinafter with reference to the drawings, but the present disclosure is not limited to these specific embodiments. The specific embodiments described below may be combined with each other, and the same or similar concepts or processes may not be described in detail in certain embodiments. Furthermore, in one or more embodiments, a specific feature, structure, or characteristic may be combined in any suitable manner that will be clear to those of ordinary skill in the art from the present disclosure.

It is to be understood that the present disclosure does not limit how to obtain an image to be applied/processed. In some embodiments of the present disclosure, the image may be obtained from a storage apparatus, such as an internal memory or an external storage apparatus. In some other embodiments of the present disclosure, a photographing component may be mobilized to take a picture. It should be noted that the obtained image may be a captured image or a frame of image in a captured video, which is not particularly limited thereto.

In the context of the present disclosure, an image may refer to any of a variety of images, such as a color image, a gray image, or the like. It should be noted that in the context of this specification, the type of the image is not specifically limited. Furthermore, the image may be any appropriate image, such as an original image obtained by a photographing apparatus, or an image that has been subjected to specific processing on the original image, such as preliminary filtering, anti-aliasing, color adjustment, contrast adjustment, normalization, or the like. It should be noted that the pre-processing operation may also include other types of pre-processing operations known in the art, which will not be described in detail herein.

In the related art, a reply is generated based only on an image uploaded by a user, which is difficult to meet the user’s needs.

The present disclosure provides a content generation method and apparatus, and a computer-readable storage medium, which can improve the quality of generated content.

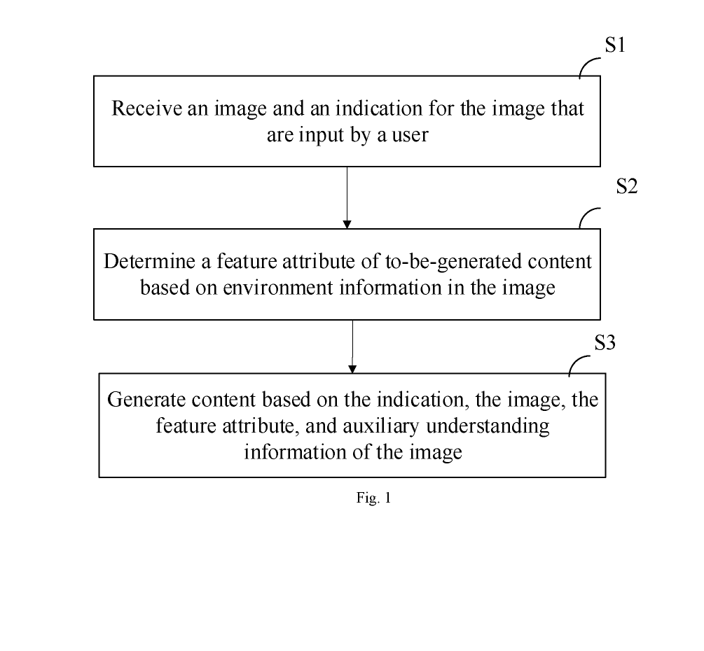

FIG. 1 is a schematic flowchart of a content generation method according to some embodiments of the present disclosure.

As shown in FIG. 1, the content generation method includes: in step S1, receiving an image and an indication for the image that are input by a user; in step S2, determining a feature attribute of to-be-generated content based on environment information in the image; and in step S3, generating content based on the indication, the image, the feature attribute, and auxiliary understanding information of the image.

For example, the user uploads an image and simultaneously inputs an indication. The indication of the user is, for example, an operation-type indication, such as editing the image and generating a new image based on the input image. The indication of the user may also be a question, such as asking for related information of the image.

The environment information is, for example, various information that may reflect a scene, an atmosphere, a background, or the like. In the case where a main object exists in the image, the environment information is, for example, information of an area other than the main object in the image.

The generated content may be text, such as a description of the image content, analysis and interpretation of the image, related knowledge of an object in the image, a copy related to the image, and recognition of text in the image.

The generated content may also be an image or video, such as providing the user with an edited image, a newly generated image, or a video.

The "feature attribute" is, for example, a property and characteristic that the generated content has, which may reflect the feature of the generated content itself and affect the expression effect and information transmission. The feature attribute of the to-be-generated content is, for example, a style, a color, a layout and a texture of the image, and a spatial and positional relationship of elements in the image. The feature attribute may also be a type of the image, such as a photographic photo, a painting, an illustration, a chart, and animation. The feature of the to-be-generated content may also be a language style, an emotional tendency, a text structure, a genre, a layout, or the like of the text.

The auxiliary understanding information is, for example, descriptive information related to the image, and the auxiliary understanding information describes various shooting information, tag information, or the like of the image, for example, but does not directly constitute the visual content of the image itself.

The content generation method in this embodiment may be performed on a client, or may be partially performed on a server.

According to this embodiment, a feature attribute of to-be-generated content is determined based on environment information in an image, such that the environment information may be fully utilized, and the correlation between the generated content and the image input by the user is improved. Moreover, compared with generating content only based on the image itself, the auxiliary understanding information provides additional information, which is helpful to improve the matching between the generated content and the user’s needs. In summary, the introduction of the environment information and the auxiliary understanding information may improve the quality of the generated content.

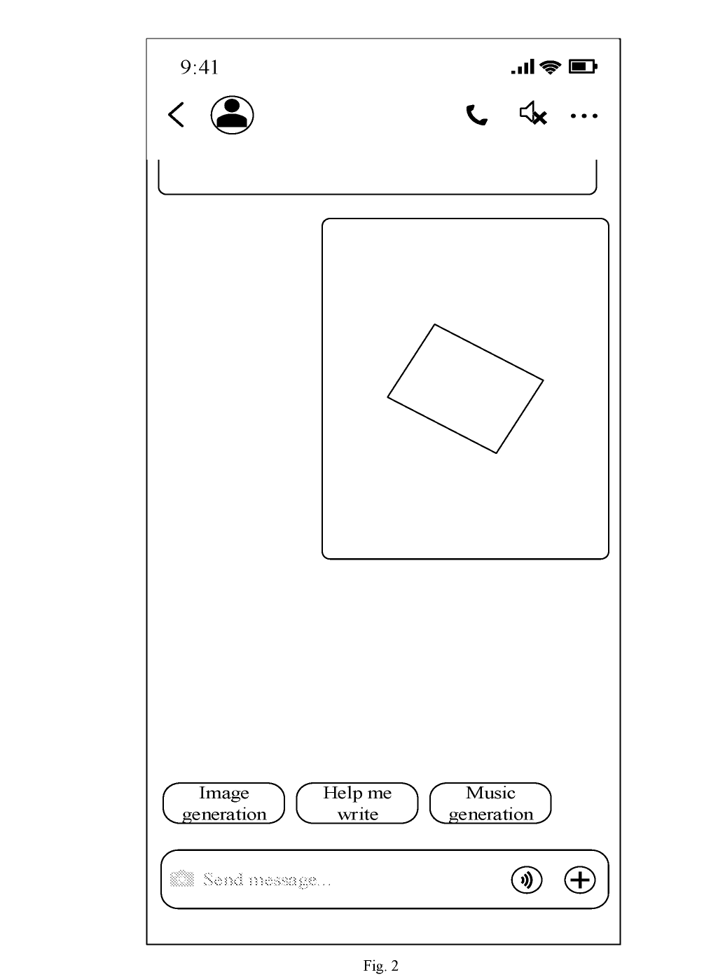

FIG. 2 is a schematic diagram of receiving a user input according to some embodiments of the present disclosure.

A method for receiving a user input according to some embodiments of the present disclosure is described below with reference to FIG. 2.

In some embodiments, receiving an image and an indication for the image that are input by a user includes: receiving the image and auxiliary understanding information that are input by the user; and generating and displaying guidance information based on the auxiliary understanding information, where the guidance information is configured to guide the user to input the indication for the image.

For example, as shown in FIG. 2, when the user inputs an image but has not input an indication for the image, the guidance information such as "image generation", "help me write", "explain the meaning of this image", and "intelligent search" may be generated and displayed.

The auxiliary understanding information includes, for example, information of a shooting device, shooting location information, time, a title, classification information, description information, source information, weather information, resolution information, or the like of the image. The auxiliary understanding information may also be metadata of the image.

"Image generation" represents, for example, that the user desires to generate a similar image based on the image input by the user. If the auxiliary understanding information includes the resolution of the image, and the resolution of the image is low, the user may want to generate a similar image with a high resolution. In this case, the guidance information "image generation" may be displayed.

"Help me write" represents, for example, that the user desires an intelligent assistant to write based on or inspired by the content in the image. If the auxiliary understanding information includes shooting time and location information (such as longitude and latitude), and it is determined, based on the shooting time and location information, that the user may have shot the image at a certain scenic spot, the user may want to obtain a travel note for sharing on social media after inputting the image. In this case, the guidance information "help me write" may be provided.

"Explain the meaning of this image" represents that the user wants to know the inner meaning, the expressed theme, the conveyed emotion, or the like of the image input by the user. If some keywords or descriptive tags, such as "abstract art", exist in the auxiliary understanding information, the user may want to know the deep meaning, the main idea, or the like of the image. In this case, the guidance information "explain the meaning of this image" may be provided.

"Intelligent search" represents that the user desires to perform intelligent retrieval based on the content of the image, such as searching for information or other images related to an element in the image. For example, if the auxiliary understanding information includes the model of the shooting device, and the device of this model is commonly used in a specific field (such as landscape or animal photography), the user may be a photography enthusiast in this field and may want to find similar photographic images for appreciation or learning. In this case, "intelligent search" may be prompted.

The guidance information is, for example, in the form of options, and the user may select an option as an instruction without manually inputting the instruction word by word.

In some embodiments, receiving an image and an indication for the image that are input by a user includes: receiving a file input by the user; and extracting the image and auxiliary understanding information from the file, where the auxiliary understanding information includes at least one of: information of a shooting device, shooting location information, time, a title, classification information, an image description, source information, weather information, or resolution of the image.

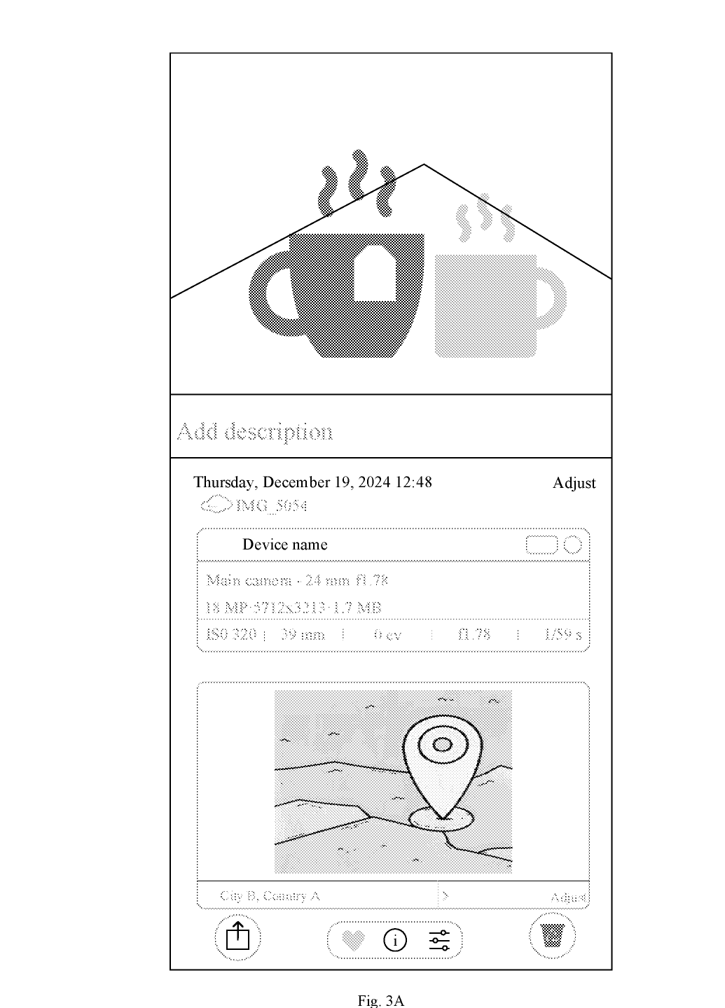

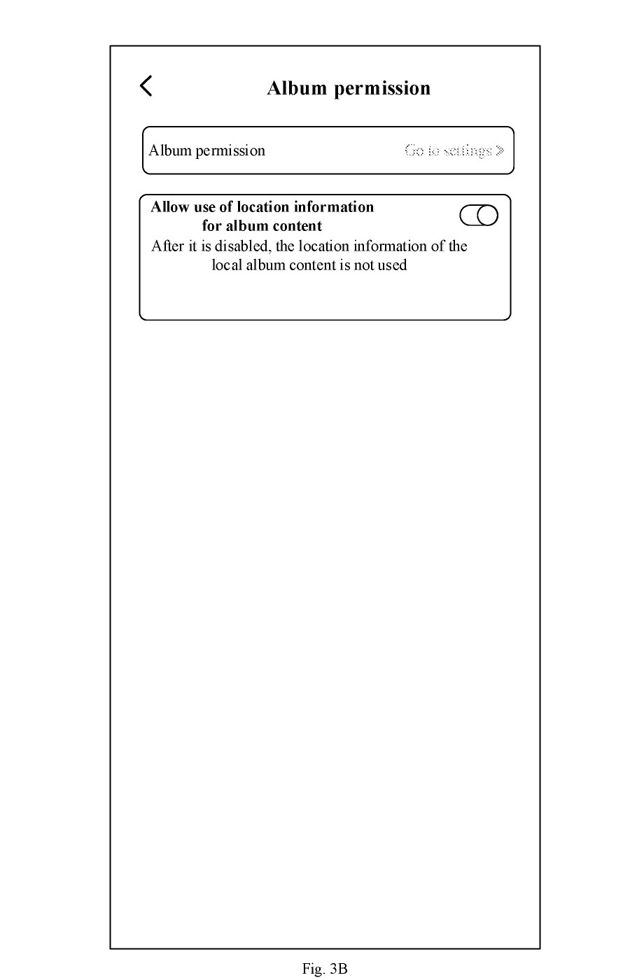

FIGS. 3A-3B are schematic diagrams of receiving auxiliary understanding information according to some embodiments of the present disclosure.

The auxiliary understanding information is, for example, data in an exchangeable image file format (EXIF). As shown in FIG. 3A, the EXIF data is usually embedded in the metadata of the image file and is closely combined with the image file itself. When the file input by the user is received, the auxiliary understanding information may be read from the file and distinguished from the pixel information of the image itself.

Before the auxiliary understanding information is used, it is necessary to first obtain authorization from the user and make disclosure in a related user agreement. For example, as shown in FIG. 3B, the auxiliary understanding information is obtained only when the user enables the position information reading function of the album content.

A method for determining a feature attribute according to some embodiments of the present disclosure is described below.

In some embodiments, determining a feature attribute of to-be-generated content based on environment information in an image includes: determining a relationship between entities in the image based on the environment information in the image; and determining the feature attribute of the to-be-generated content based on the relationship between the entities.

The entities in the image include, for example, a person, an animal, a still life, a natural scene, or the like. The relationship between the entities is, for example, a relationship between a main entity and a secondary entity. The main entity is, for example, an entity directly related to the content of the image, such as a core figure, a key item, or a landmark scene of an event in a news picture. The secondary entity is, for example, an entity that plays an auxiliary role for the main entity or exists as a background.

For example, the image is a living room scene, in which an old man is leaning on a sofa and holding a cup of tea in his hand, and a child is holding a story book. The sofa, the tea, and the story book are secondary entities. It may be seen from the relationship between the old man and the sofa and the tea and the relationship between the child and the story book that the image depicts a warm life picture. Based on this, the feature attribute of the to-be-generated content is, for example, a warm and intimate style.

In some embodiments, determining a feature attribute of to-be-generated content based on environment information in an image includes: determining action information of an entity in the image based on the environment information in the image; and determining the feature attribute of the to-be-generated content based on the action information.

For example, the feature attribute of the to-be-generated content may be determined by combining the action information of the main entity and the action information of the secondary entity in the image. In the case where the feature of the action information of the main entity is not obvious, the feature attribute of the to-be-generated content may also be determined based on the action information of the secondary entity in the image. For example, the image uploaded by the user includes a person, and a cat is lying on the floor on its back, with its eyes half-closed, its belly exposed, and its limbs stretched out. Based on the action of the cat, it is determined that the cat is in a relaxed state and in a happy mood, thereby determining that the feature attribute of the to-be-generated content is happy and relaxed.

In some embodiments, determining a feature attribute of to-be-generated content based on environment information in an image includes: determining a type of an environment based on the environment information in the image, where the type includes a natural environment and a non-natural environment; and determining the feature attribute of the to-be-generated content based on the type of the environment.

A modern and concise style may be adopted for the non-natural environment, and emphasis is placed on practicality and information transmission. The reply type includes, for example, an informative reply, historical and cultural popular science, or the like. For example, the user uploads a photo of a city, in which there are high-rise buildings, belonging to the city type in the non-natural environment. Based on the type of the environment, the feature attribute of the to-be-generated content is determined to be, for example, simple and modern.

A lyrical and literary style may be adopted for the natural environment. The content type may include scenery description, related poetry recommendation, or the like. For example, when the user uploads a photo of a snow mountain, which belongs to the natural scenery type, the feature attribute of the to-be-generated content is determined to be literary and lyrical.

Determining the feature attribute of the to-be-generated content by combining the type of the environment enables the reply of the intelligent assistant to be more in line with the actual application scenario, thereby improving the user experience.

In some embodiments, determining a feature attribute of to-be-generated content based on environment information in an image includes: determining visual effect information based on the environment information in the image, where the visual effect information includes at least one of light information or color information; and determining the feature attribute of the to-be-generated content based on the visual effect information.

For example, the user uploads a photo taken at dusk, in which the light is relatively soft and the hue is also warm, and the feature attribute of the to-be-generated content is determined to be lyrical and warm. By analyzing the light and color information in the image, the intelligent assistant may better understand the user’s intention and provide content that matches the user’s current emotional state or interest.

A method for generating content according to some embodiments of the present disclosure is described below.

In some embodiments, generating content based on an indication of a user, an image, a feature attribute, and auxiliary understanding information of the image includes: generating prompt information based on the indication and the feature attribute; and generating, using a machine learning model, the content based on the prompt information, the image, and the auxiliary understanding information of the image.

The indication of the user includes, for example, an intention to generate text or an intention to generate an image. For example, the user inputs: "generate a copy based on this photo" or "generate a new image based on the style of this photo".

A new instruction or prompt is generated based on the feature attribute and the indication of the user, and the prompt information may be used as input of an image-to-text model or a text generation model. For example, if the user indicates generating a copy, and the feature attribute of the photo of the snow mountain has been determined to be literary and lyrical, the generated prompt information is, for example, "generate a copy based on the image in a literary and lyrical style". If the user indicates generating an image, the prompt information is, for example, "generate a new image in a literary and lyrical style with reference to the image uploaded by the user".

Based on the generated prompt information, the intelligent assistant performs a corresponding operation. If the prompt information is to generate a copy, the intelligent assistant uses the natural language processing technology to create a piece of text content that meets the requirements based on the required text feature attribute. If the prompt information is to generate an image, the intelligent assistant uses the image generation technology to generate a new image that meets the user’s indication with reference to the feature attribute of the original image.

The generated prompt information varies based on different feature attributes and different user indications. Different environment features in the image may result in different description focuses and style requirements, and different image-to-image or image-to-text intentions of the user may also result in different requirements in the prompt information.

In some embodiments, generating prompt information based on an indication and a feature attribute includes: in response to the indication including generating a target image, determining a visual attribute of the target image to be generated based on the feature attribute and the indication; and generating the prompt information based on the visual attribute of the image to be generated.

For example, the feature attribute is an overall requirement for the image style, and more detailed visual attributes are determined by combining the feature attribute and the indication of the user, that is, the visual attribute contains more information than the feature attribute. The visual attribute of the image includes, for example, a color, a texture, a shape, a spatial relationship, or the like.

For example, the image uploaded by the user is an endless sea, with a white couch on the beach and a person on the couch. The user indicates generating an image as "generating an image of a mountaintop". Based on the environment of the uploaded image, the feature attribute is determined to be broad space and fresh color. The visual attribute of the image is determined to be blue, green, white, and broad space by combining the indication of the user and the feature attribute. The prompt generated based on the visual attribute is, for example: "a sunny mountaintop vacation scene with a blue sky as the background and a wooden house with a white window frame. Green vegetation grows on the mountaintop. The distant view is a vast mountain range, and the overall picture creates a broad vision."

In some embodiments, generating prompt information based on an indication and a feature attribute includes: in response to the indication including generating text, determining a text attribute of the text to be generated based on the feature attribute and the indication, where the text attribute includes at least one of a semantic attribute or a format attribute; and generating the prompt information based on the text attribute.

For example, the user uploads a portrait photo in a forest, and the user indicates generating a text description of the photo for sharing on social media. Based on the photo, the feature attribute is determined to be the natural environment. Based on the feature attribute and the indication of the user, the semantic attribute is determined to be describing the natural beauty and emphasizing tranquility and vitality, and the format attribute may also be determined to be: being well structured and easy to read. Based on this, the generated prompt information is: please create a piece of prose that depicts the natural beauty, is well structured and easy to read, and highlights tranquility and vitality.

In some embodiments, the auxiliary understanding information includes information about a shooting device of the image, and generating content based on an indication, an image, a feature attribute, and auxiliary understanding information of the image includes: generating the content based on the information about the shooting device of the image, the indication, the image, and the feature attribute.

For example, user preference is determined based on the information of the shooting device of the user. If the photo is taken by a mobile phone, the user may be more inclined to convenience and daily life, and the generated content may be more daily accordingly. If the photo is taken by a camera of a certain brand, the content may be generated based on a user portrait of users who use this type of brand camera.

In some embodiments, the auxiliary understanding information includes at least one of shooting location information or shooting time of the image, and generating content based on an indication, an image, a feature attribute, and auxiliary understanding information of the image includes: determining a theme of the to-be-generated content based on the at least one of the shooting location information or the shooting time; and generating the content based on the indication, the image, the feature attribute, and the theme.

The shooting location information of the image is, for example, a street, a building name, a city, a country, and a natural landscape location. The shooting time is, for example, a year, a month, a day, and the like. For example, the shooting location of the image is place A, and the time is summer. If place A is famous for the blooming of a certain flower in summer, the theme may be the flower.

In some embodiments, generating content based on an indication, an image, a feature attribute, and auxiliary understanding information of the image includes: receiving historical interaction information with the user; determining an association relationship between the historical interaction information and the auxiliary understanding information; and generating the content based on the indication of the user, the image, the feature attribute, the auxiliary understanding information, and the association relationship.

For example, information related to the historical interaction information of the user in the auxiliary understanding information may be found, and the content may be generated based on the related information.

For example, if the user has previously asked about shooting parameters, and the user uploads a photo taken at a tourist attraction and indicates: "How is this picture taken", the intelligent assistant searches for information related to the shooting parameters in the auxiliary understanding information. The information related to the shooting parameters includes, for example, an aperture, a depth of field, a shutter speed, and the like. Based on these shooting parameters, the content may be generated, for example, to provide a suggestion: "When you took this photo, you set the aperture to f/4 and the shutter speed to 1/125 second. If you want to try more creative shooting in the future, you may use a larger aperture and a lower shutter speed."

In some embodiments, the auxiliary understanding information includes text, and generating content based on an indication, an image, a feature attribute, and auxiliary understanding information of the image includes: in response to the indication including generating text, determining, based on the indication, that generated text includes part or all of the auxiliary understanding information.

For example, the user indicates that the intelligent assistant answers a question, and if certain information in the auxiliary understanding information is the answer to the question, the generated reply information includes the information.

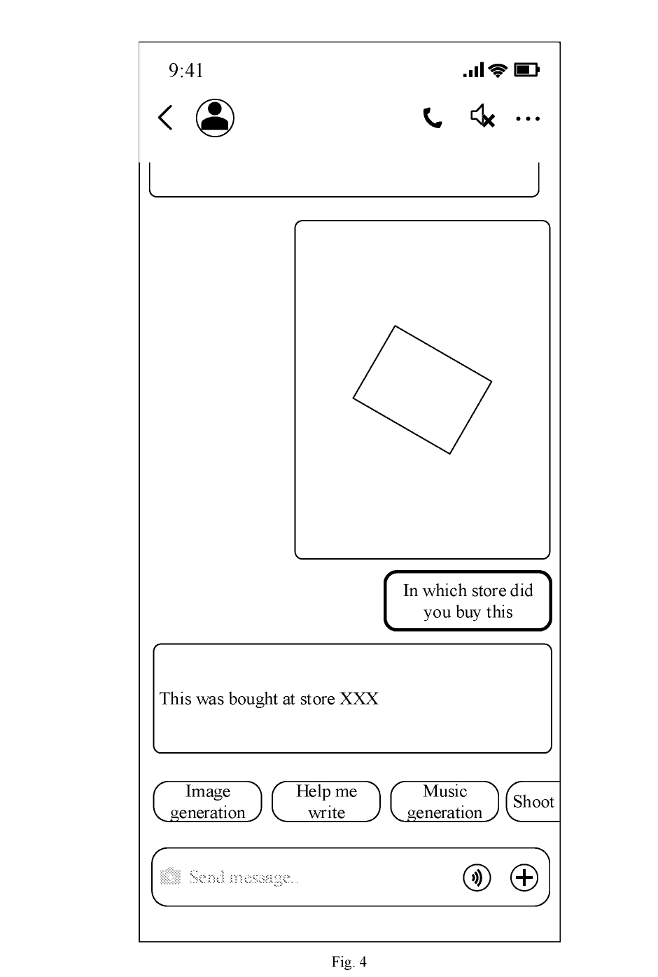

FIG. 4 is a schematic diagram of displaying a reply according to some embodiments of the present disclosure.

As shown in FIG. 4, the user uploads an image of an item, and the user indicates: "In which store did you buy this". The auxiliary understanding information includes the shooting address "store XXX" of the user, and the generated reply information includes the auxiliary understanding information, for example, the reply is "This was bought at store XXX".

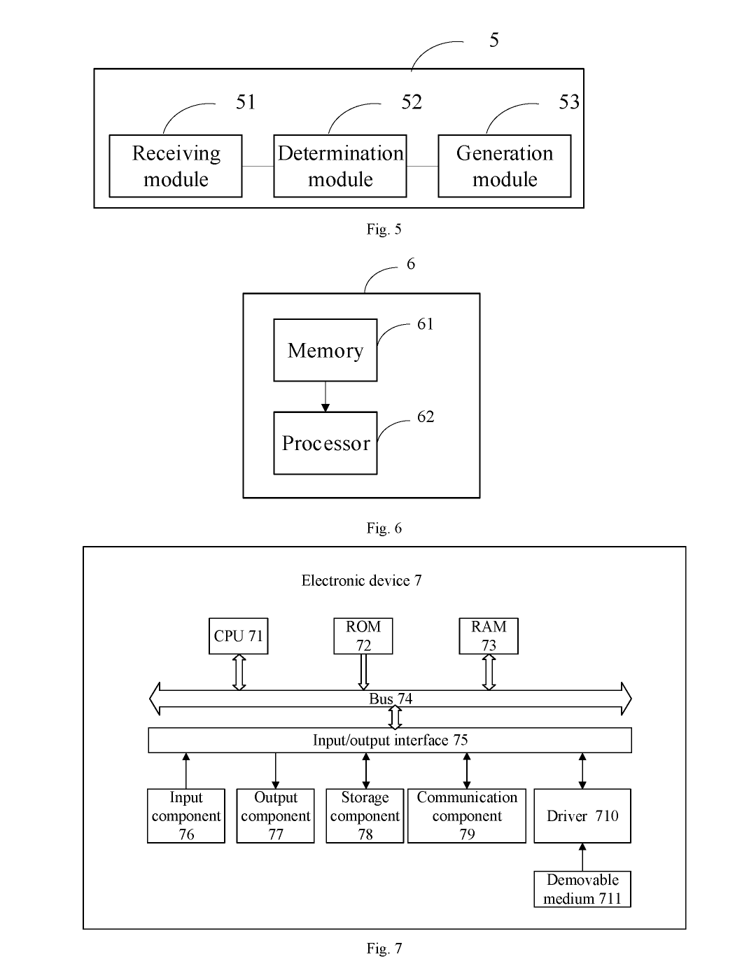

FIG. 5 is a block diagram of a content generation apparatus according to some embodiments of the present disclosure.

As shown in FIG. 5, the content generation apparatus 5 includes: a receiving module 51 configured to receive an image and an indication for the image that are input by a user; a determination module 52 configured to determine a feature attribute of to-be-generated content based on environment information in the image; and a generation module 53 configured to generate content based on the indication, the image, the feature attribute, and auxiliary understanding information of the image.

The receiving module 51 of the content generation apparatus 5 may be configured to perform step S1 in FIG. 1, the determination module 52 of the content generation apparatus 5 may be configured to perform step S2 in FIG. 1, and the generation module 53 of the content generation apparatus 5 may be configured to perform step S3 in FIG. 1.

The content generation apparatus according to some embodiments of the present disclosure determines a feature attribute of to-be-generated content based on environment information in an image, such that the environment information may be fully utilized, and the correlation between the generated content and the image input by the user is improved. Moreover, compared with generating content only based on the visual feature of the image itself, the auxiliary understanding information provides additional information, which is helpful to improve the matching between the generated content and the user’s needs.

According to some other embodiments of the present disclosure, an electronic device is provided, including: a memory; and a processor coupled to the memory, where the processor is configured to execute, based on instructions stored in the memory, the content generation method according to some embodiments of the present disclosure. The electronic device according to some embodiments of the present disclosure determines a feature attribute of to-be-generated content based on environment information in an image, such that the environment information may be fully utilized, and the correlation between the generated content and the image input by the user is improved. Moreover, compared with generating content only based on the visual feature of the image itself, the auxiliary understanding information provides additional information, which is helpful to improve the matching between the generated content and the user’s needs.

FIG. 6 is a block diagram of an electronic device according to some embodiments of the present disclosure.

The memory 61 is configured to store one or more computer-readable instructions. The memory 61 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. The memory 61 may store, for example, an operating system, an application, a boot loader, a database, and other programs, and may also store various applications, various data, and the like.

The processor 62 is configured to run the computer-readable instructions to implement the content generation method described in any one of the embodiments or the method described in any one of the embodiments. For the specific implementation of each step of the method, reference may be made to the foregoing embodiments, and details of the same parts are not described herein again.

The processor 62 may be configured to perform the steps in FIG. 1. The processor 62 may be embodied as various processing apparatuses, such as a central processing unit (CPU) and a network processor (NP) or the like. Alternatively, the processor 62 may be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 62 and the memory 61 may directly or indirectly communicate with each other. For example, the processor 62 and the memory 61 may communicate through a network. The network may include a wireless network, a wired network, and/or any combination of a wireless network and a wired network. The processor 62 and the memory 61 may also communicate with each other through a system bus, which is not limited in the present disclosure.

It should be noted that the components of the electronic device 6 shown in FIG. 6 are merely exemplary and non-restrictive, and the electronic device 6 may have other components according to actual application needs. The processor 62 may control other components in the electronic device 6 to perform desired functions.

The electronic device 6 may be implemented by software, firmware, and/or hardware, and may be integrated into an apparatus in which a related application is installed.

FIG. 7 is a block diagram of an electronic device according to some other embodiments of the present disclosure.

The electronic device 7 shown in FIG. 7 may be a computer system having a dedicated hardware structure, and may perform corresponding functions when a related application is installed.

The electronic device includes, but is not limited to, a mobile terminal such as a smartphone, a notebook computer, a personal digital assistant (PDA), a tablet personal computer (Tablet PC), a portable media player (PMP), and a vehicle-mounted terminal (such as a vehicle navigation terminal), and a fixed terminal such as a digital television and a desktop computer.

As shown in FIG. 7, a central processing unit (CPU) 71 performs various processes based on a program stored in a read-only memory (ROM) 72 or a program loaded from a storage component 78 into a random access memory (RAM) 73. The RAM 73 stores data required when the CPU 71 performs various processes, as needed. The central processing unit is merely exemplary, and it may be another type of processor, such as the various processors described above. The ROM 72, the RAM 73, and the storage component 78 may be various forms of computer-readable storage media. It should be noted that although the ROM 72, the RAM 73, and the storage component 78 are shown separately in FIG. 7, one or more of them may be combined or located in the same or different memories or storage modules.

The CPU 71, the ROM 72, and the RAM 73 are connected to each other via a bus 74. An input/output interface 75 is also connected to the bus 74.

The following components are connected to the input/output interface 75: an input component 76, such as a touch screen, a touchpad, a keyboard, a mouse, an image sensor, a microphone, an accelerometer, a gyroscope, or the like; an output component 77, including a display, such as a cathode ray tube (CRT) and a liquid crystal display (LCD), a speaker, a vibrator, or the like; the storage component 78, including a hard disk, a magnetic tape, or the like; and a communication component 79, including a network interface card, such as a LAN card and a modem. The communication component 79 allows communication processing to be performed via a network such as the Internet. It is easily understood that although the components in the electronic device 7 are shown in FIG. 7 to communicate through the bus 74, they may also communicate through a network or other means, where the network may include a wireless network, a wired network, and/or any combination of a wireless network and a wired network.

According to need, a driver 710 is also connected to the input/output interface 75. A removable medium 711, such as a magnetic disk, an optical disc, a magneto-optical disc, a semiconductor memory, or the like, is installed on the driver 710 as needed, so that a computer program read therefrom is installed into the storage component 78 as needed.

In the case where the above-described series of processes are implemented by software, a program constituting the software may be installed from a network such as the Internet or a storage medium such as the removable medium 711.

According to the embodiments of the present disclosure, the process described above with reference to the flowchart may be implemented as a computer software program. For example, some embodiments of the present disclosure include a computer program product, which, when running on a computer, causes the computer to implement the method described in any one of the embodiments. The computer program product includes computer instructions carried on a computer-readable medium, and includes program code for performing the method shown in the flowchart. In such an embodiment, the computer instructions may be downloaded and installed from a network through the communication component 79, or installed from the storage component 78, or installed from the ROM 72. When the computer program is executed by the CPU 71, the method of the embodiments of the present disclosure is executed.

It should be noted that in the context of the present disclosure, a computer-readable medium may be a tangible medium that may include or store a program for use by or in combination with an instruction execution system, apparatus, or device.

The computer-readable medium may be a computer-readable storage medium, or a computer-readable signal medium, or any combination of the two.

The computer-readable storage medium includes, but is not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that includes or stores a program, and the program may be used by or in combination with an instruction execution system, apparatus, or device. The computer-readable storage medium has computer instructions stored thereon, and the instructions, when executed by a processor, implement the method described in any one of the embodiments.

The computer-readable signal medium may include a data signal propagated on a baseband or as a part of a carrier wave, and computer-readable program code is carried thereon. This propagated data signal may adopt multiple forms, including, but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program for use by or in combination with an instruction execution system, apparatus, or device. The program code contained on the computer-readable medium may be transmitted by any suitable medium, including, but not limited to: a wire, an optical cable, a radio frequency (RF), etc., or any suitable combination of the above.

The above computer-readable medium may be included in the above electronic device, or may exist alone without being assembled into the electronic device.

In some embodiments, a computer program is provided, including: instructions that, when executed by a processor, cause the processor to perform the method described in any one of the embodiments. For example, the instructions may be embodied as computer program code.

In the embodiments of the present disclosure, the computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as "C" language or similar programming languages. The program code may be completely executed on a user computer, partially executed on a user computer, executed as an independent software package, partially executed on a user computer and partially executed on a remote computer, or completely executed on a remote computer or server. In the case involving a remote computer, the remote computer may be connected to the user computer through any kind of network (including a local area network (LAN) or a wide area network (WAN)), or may be connected to an external computer (for example, connected by using Internet provided by an Internet service provider).

The flowchart and block diagram in the drawings illustrate the possibly implemented architectures, functions, and operations of the systems, methods, and computer program products according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), or the like.

According to some other embodiments of the present disclosure, a computer-readable storage medium is provided, having computer program instructions stored thereon, where when the instructions are executed by a processor, the content generation method according to some embodiments of the present disclosure is implemented. The processor determines a feature attribute of to-be-generated content based on environment information in an image, such that the environment information may be fully utilized, and the correlation between the generated content and the image input by the user is improved. Moreover, compared with generating content only based on the visual feature of the image itself, the auxiliary understanding information provides additional information, which is helpful to improve the matching between the generated content and the user’s needs.

According to some other embodiments of the present disclosure, a computer program product is provided, including computer program instructions, where when the computer program instructions are executed by a processor, the content generation method according to some embodiments of the present disclosure is implemented. The processor determines a feature attribute of to-be-generated content based on environment information in an image, such that the environment information may be fully utilized, and the correlation between the generated content and the image input by the user is improved. Moreover, compared with generating content only based on the visual feature of the image itself, the auxiliary understanding information provides additional information, which is helpful to improve the matching between the generated content and the user’s needs.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

1. A content generation method, comprising:
receiving an image and an indication for the image that are input by a user;
determining a feature attribute of to-be-generated content based on environment information in the image; and
generating content based on the indication, the image, the feature attribute, and auxiliary understanding information of the image.

2. The content generation method according to claim 1, wherein determining the feature attribute of the to-be-generated content based on the environment information in the image comprises:
determining a relationship between entities in the image based on the environment information in the image; and
determining the feature attribute of the to-be-generated content based on the relationship between the entities.

3. The content generation method according to claim 1, wherein determining the feature attribute of the to-be-generated content based on the environment information in the image comprises:
determining action information of an entity in the image based on the environment information in the image; and
determining the feature attribute of the to-be-generated content based on the action information.

4. The content generation method according to claim 1, wherein determining the feature attribute of the to-be-generated content based on the environment information in the image comprises:
determining a type of an environment based on the environment information in the image, wherein the type comprises a natural environment and a non-natural environment; and
determining the feature attribute of the to-be-generated content based on the type of the environment.

5. The content generation method according to claim 1, wherein determining the feature attribute of the to-be-generated content based on the environment information in the image comprises:
determining visual effect information based on the environment information in the image, wherein the visual effect information comprises at least one of light information or color information; and
determining the feature attribute of the to-be-generated content based on the visual effect information.

6. The content generation method according to claim 1, wherein generating content based on the indication of the user, the image, the feature attribute, and the auxiliary understanding information of the image comprises:
generating prompt information based on the indication and the feature attribute; and
generating, using a machine learning model, the content based on the prompt information, the image, and the auxiliary understanding information of the image.

7. The content generation method according to claim 6, wherein generating the prompt information based on the indication and the feature attribute comprises:
determining, in response to the indication comprising generating a target image, a visual attribute of the target image to be generated based on the feature attribute and the indication; and
generating the prompt information based on the visual attribute of the target image to be generated.

8. The content generation method according to claim 6, wherein generating the prompt information based on the indication and the feature attribute comprises:
determining, in response to the indication comprising generating text, a text attribute of the text to be generated based on the feature attribute and the indication, wherein the text attribute comprises at least one of a semantic attribute or a format attribute; and
generating the prompt information based on the text attribute.

9. The content generation method according to claim 1, wherein the auxiliary understanding information comprises information about a shooting device of the image, and generating content based on the indication, the image, the feature attribute, and the auxiliary understanding information of the image comprises:
generating the content based on the information about the shooting device of the image, the indication, the image, and the feature attribute.

10. The content generation method according to claim 1, wherein the auxiliary understanding information comprises at least one of shooting location information or shooting time of the image, and generating content based on the indication, the image, the feature attribute, and the auxiliary understanding information of the image comprises:
determining a theme of the to-be-generated content based on the at least one of the shooting location information or the shooting time; and
generating the content based on the indication, the image, the feature attribute, and the theme.

11. The content generation method according to claim 1, wherein generating content based on the indication, the image, the feature attribute, and the auxiliary understanding information of the image comprises:
receiving historical interaction information with the user;
determining an association relationship between the historical interaction information and the auxiliary understanding information; and
generating the content based on the indication of the user, the image, the feature attribute, the auxiliary understanding information, and the association relationship.

12. The content generation method according to claim 1, wherein generating content based on the indication, the image, the feature attribute, and the auxiliary understanding information of the image comprises:
determining, in response to the indication comprising generating text, that generated text comprises part or all of the auxiliary understanding information based on the indication.

13. The content generation method according to claim 1, wherein receiving an image and an indication for the image that are input by a user comprises:
receiving the auxiliary understanding information of the image; and
generating and displaying guidance information based on the auxiliary understanding information, wherein the guidance information is configured to guide the user to input the indication for the image.

14. The content generation method according to claim 1, wherein receiving an image and an indication for the image that are input by a user comprises:
receiving a file input by the user; and
extracting, from the file, the image and the auxiliary understanding information, wherein the auxiliary understanding information comprises at least one of: information about a shooting device, shooting location information, time, a title, classification information, description information, source information, weather information, or resolution of the image.

15. An electronic device, comprising:
a memory; and
a processor coupled to the memory, wherein the processor is configured to execute, based on instructions stored in the memory, a content generation method, wherein the content generation method comprises:
receiving an image and an indication for the image that are input by a user;
determining a feature attribute of to-be-generated content based on environment information in the image; and
generating content based on the indication, the image, the feature attribute, and auxiliary understanding information of the image.

16. The electronic device according to claim 15, wherein determining the feature attribute of the to-be-generated content based on the environment information in the image comprises:
determining a relationship between entities in the image based on the environment information in the image; and
determining the feature attribute of the to-be-generated content based on the relationship between the entities.

17. The electronic device according to claim 15, wherein determining the feature attribute of the to-be-generated content based on the environment information in the image comprises:
determining action information of an entity in the image based on the environment information in the image; and
determining the feature attribute of the to-be-generated content based on the action information.

18. A non-transitory computer-readable storage medium having computer program instructions stored thereon, wherein when the instructions are executed by a processor, a content generation method is implemented, wherein the content generation method comprises:
receiving an image and an indication for the image that are input by a user;
determining a feature attribute of to-be-generated content based on environment information in the image; and
generating content based on the indication, the image, the feature attribute, and auxiliary understanding information of the image.

19. The non-transitory computer-readable storage medium according to claim 18, wherein determining the feature attribute of the to-be-generated content based on the environment information in the image comprises:
determining a relationship between entities in the image based on the environment information in the image; and
determining the feature attribute of the to-be-generated content based on the relationship between the entities.

20. The non-transitory computer-readable storage medium according to claim 18, wherein determining the feature attribute of the to-be-generated content based on the environment information in the image comprises:
determining action information of an entity in the image based on the environment information in the image; and
determining the feature attribute of the to-be-generated content based on the action information.
